(19) United States
(12) Patent Application Publication
(10) Pub. No.: US 2026/0288437 A1
(43) Pub. Date: Sep. 24, 2026

(54) MODEL DEPLOYMENT SYSTEM FOR GENERATING OPTIMIZED MODELS FOR A TARGET ENVIRONMENT

(71) Applicant: Oracle International Corporation, Redwood Shores, CA (US)

(72) Inventors: Shakti Pratap Singh, San Jose, CA (US); Nishanth Prakash, San Jose, CA (US)

(73) Assignee: Oracle International Corporation, Redwood Shores, CA (US)

(21) Appl. No.: 19/088,846

(22) Filed: Mar. 24, 2025

(51) Int. Cl. G06F 8/60; G06F 8/41; G06N 3/04

(52) U.S. Cl. CPC G06F 8/60; G06F 8/41; G06N 3/04

(57) ABSTRACT

A model deployment system (MDS) is disclosed that includes capabilities for generating an optimized model that is tailored to specific target deployment hardware used to deploy the model in a target environment. The MDS is capable of executing a model inference accelerator (MIA) layer to perform a set of optimizations on a machine learning (ML) model. The MIA layer executes the set of optimizations based on model metadata associated with the ML model to generate an optimized ML model. The execution performed by the MIA layer includes generating an intermediate representation (IR) format for the IR model that identifies model-specific optimizations to be applied to the ML model and target hardware for deploying the ML model. The execution by the MIA layer further includes compiling the IR format of the ML model based on model-specific optimizations and target hardware-specific model optimizations to generate an optimized ML model.

### BACKGROUND

Model deployment refers to the process of integrating a trained model into a live production environment, allowing the model to make predictions (inferences) on new data and to be used for real-world decision-making within an application or system. Once deployed on a target system, the model can be used to receive input data, generate predictions based on its learned patterns, and provide valuable insights for business operations. There are several challenges that can arise during the model deployment process. For instance, the hardware used to build and train a model can vary significantly from the target hardware used for model deployment. Models are usually built, trained and compiled on high performance machines and, in many instances, deployed on target devices (such as, for e.g., cameras, mobile devices, smart speakers in motor vehicles and so on) that typically have smaller hardware specifications than the hardware used for model training. Due to the limited processing power and resource capabilities of a target device, the inference efficiency and performance of a model can oftentimes be impacted.

Model optimization is a process that aims to improve the inference efficiency and performance of a model prior to its deployment on a target device. Optimizing a model can often result in a smaller model size, which translates to less memory needed to store and run the model on a target device. Model optimization also reduces the computational cost and latency required to generate predictions, essentially making the model run faster and generate more accurate inferences on new data. However, existing approaches to model optimization often lack the ability to tailor the model optimization to the specific target deployment hardware that the model is designed to run on. There is thus a need for developing techniques that facilitate more efficient model optimization targeted to specific deployment hardware than what is possible by existing implementations.

### BRIEF SUMMARY

The present disclosure generally relates to performing model deployments and, more particularly, to a model deployment system that includes capabilities for generating an optimized model that is tailored to specific target deployment hardware used to deploy the model in a target environment. The model deployment system enables the generation of a model for optimal performance on target deployment hardware and improves the inference performance of the model deployed in the target environment.

In certain embodiments, a model deployment system (MDS) is disclosed that is capable of executing a model inference accelerator (MIA) layer to perform a set of optimizations on a machine learning (ML) model. The MIA layer executes the set of optimizations based on model metadata associated with the ML model to generate an optimized ML model. The execution performed by the MIA layer includes determining model-specific optimizations from the set of optimizations to be applied to the ML model based on the model metadata and determining target hardware-specific optimizations from the set of optimizations to be applied to the ML model based on the model metadata. The execution by the MIA layer then includes generating an intermediate representation (IR) format for the IR model. The IR model format identifies the model-specific optimizations to be applied to the ML model and a target hardware for deploying the ML model in a target environment. The execution by the MIA layer further includes compiling the IR format of the ML model based on the model-specific optimizations and the target hardware-specific model optimizations to generate an optimized ML model. The MDS then deploys the optimized ML model to the target hardware for deploying the ML model in the target environment.

In some examples, the model metadata comprises a type of model compiler for compiling the ML model, a target hardware for deploying the ML model in the target environment, a type of the ML model and a type of the ML model framework used to build the ML model.

In some examples, the target hardware for deploying the ML model in the target environment is identified based on the model metadata. In some examples, the target hardware identifies at least one of a Central Processing Unit (CPU) specification for deploying the ML model in the target environment, a Graphical Processing Unit (GPU) specification for deploying the ML model in the target environment or deployment accelerators for deploying the ML model in the target environment.

In some examples, the intermediate representation (IR) format for the IR model identifies a set of model components of the ML model to be deployed in the target environment.

In some examples, executing the set of model optimizations on the ML model to generate an optimized ML model by the MIA layer includes generating, by the MIA layer, a model inference script for executing the ML model in the target environment and transmitting, by the MIA layer, the optimized ML model and the model inference script to a containerized environment in the MDS.

In some examples, the model inference script comprises a loading function to load the optimized ML model onto the target hardware in the target environment. In some examples, the model inference script comprises a prediction function to return a predicted output from the ML model based on input data provided to the ML model.

In some examples, deploying the ML model in the target environment further includes mounting, by the MDS, a compilation environment comprising the optimized ML model and the model inference script to an inference container in the MDS, packaging, by the MDS, the compilation environment in an inference container image and deploying, by the MDS, the inference container image to the target device in the target environment.

In some examples, the inference container image receives a request to an inference endpoint to perform a prediction, executes the optimized ML model to generate an inference result responsive to the request and transmits the inference result to a source of the request.

Some embodiments include a system that includes one or more processing systems and one or more computer-readable media storing instructions which, when executed by the one or more processing systems, cause the system to perform part or all of the operations and/or methods disclosed herein.

Some embodiments include one or more non-transitory computer-readable media storing instructions which, when executed by one or more processing systems, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a block diagram of an example computing environment including a model deployment system for creating a model deployment and optimizing the model for target deployment hardware, according to examples described herein.

FIG. 2 is a diagram illustrating additional details of a model inference accelerator (MIA) layer used by the MDS to generate an optimized ML model that is tailored to target deployment hardware for deploying an ML model in a target environment, according to some examples.

FIG. 3 is a simplified flowchart depicting the processing performed by the subsystems of the MDS shown in FIG. 1 for generating an optimized ML model, according to certain embodiments.

FIG. 4 is a simplified flowchart depicting the processing performed by the subsystems of the MIA layer shown in FIG. 2 for generating an optimized ML model, according to certain embodiments.

FIG. 5 illustrates an example of an intermediate representation (IR) format for a machine learning (ML) model that is generated by the Model Inference Accelerator (MIA) layer shown in FIG. 1, according to certain embodiments.

FIG. 6 illustrates another example of an intermediate representation (IR) format for a machine learning (ML) model that is generated by the Model Inference Accelerator (MIA) layer shown in FIG. 1, according to certain embodiments.

FIG. 7 illustrates an example of a model inference script that is generated by the Model Inference Accelerator (MIA) layer shown in FIG. 1, according to certain embodiments.

FIG. 8 is a block diagram illustrating one pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating an example computer system, according to at least one embodiment

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure generally relates to performing model deployments and, more particularly, to a model deployment system that includes capabilities for generating an optimized model that is tailored to specific target deployment hardware used to deploy the model in a target environment. The model deployment system enables the generation of a model for optimal performance on target deployment hardware and improves the inference performance of the model deployed in the target environment.

As previously described, model deployment refers to a process by which a machine learning (ML) model can be integrated into a production environment. A model deployment system broadly enables users to create model deployments by obtaining a trained ML model built using a particular framework, saving the trained ML model in a format suitable for deployment, selecting a suitable target environment for deploying the model, deploying the ML model to the target environment and creating an endpoint or other interface for users to interact with the model for predictions (inferences). However, several challenges can arise during the model deployment process. For instance, depending on the specific target hardware used for inference, computational constraints of the target hardware can impact the accuracy of the model's inferences. Additionally, model complexity can also impact inference accuracy. Complex models usually require more computational power for inference, which can be a limitation depending on the hardware and real-time requirements of the target device.

According to examples described herein, a model deployment system (MDS) is disclosed that is capable of dynamically optimizing a ML model based on the constraints and specific capabilities of a target device used to deploy the ML model by applying model-specific optimizations and target hardware-specific model optimizations to the ML model. The MDS efficiently and accurately performs model optimization by using an abstraction layer that is provided as part of the MDS. The abstraction layer can be implemented, in part, by a “model inference accelerator (MIA) layer” within the model deployment system. The MIA layer performs model optimization by inspecting model metadata associated with the ML model and determining the appropriate optimization strategy to be applied to the model based on the model metadata and based on information identifying a target hardware for deploying the ML model in a target environment. The MIA layer generates an intermediate representation (IR) format for the ML model and applies model-specific optimizations and target hardware-specific optimizations to the IR format of the ML model. The MIA layer then compiles the IR format of the ML model based on the model-specific optimizations and the target hardware-specific optimizations to generate an optimized ML model that is optimized for specific target deployment hardware used to deploy the ML model. The MIA layer described herein additionally includes capabilities to take into consideration the hardware specifications of different target devices and perform target hardware-specific optimizations based on the constraints and capabilities of the target device. By optimizing the ML model for specific target deployment hardware, the MIA layer described herein can significantly improve the speed and efficiency of performing model inferences.

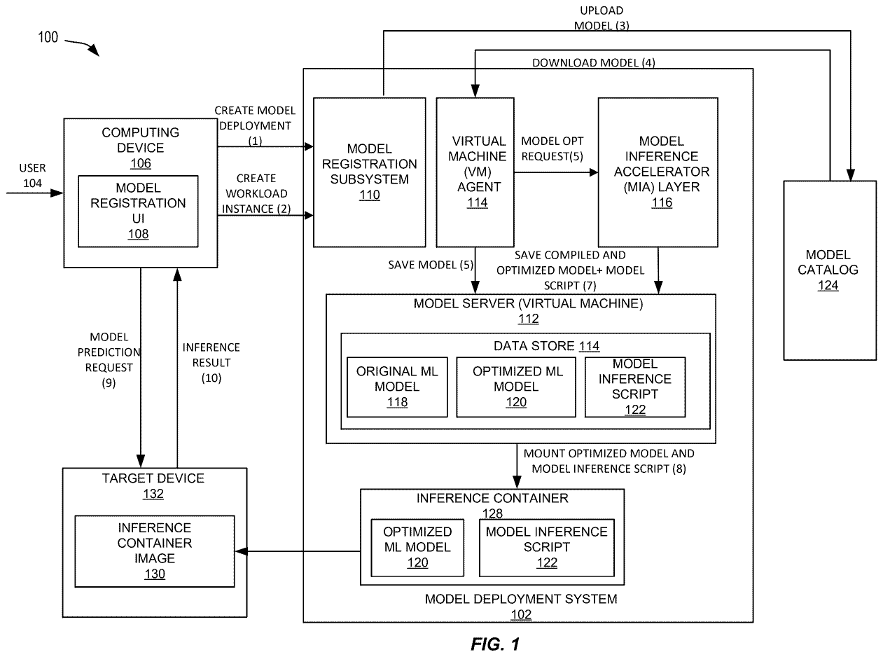

FIG. 1 is a block diagram of an example computing environment including a model deployment system for creating a model deployment and optimizing the model for target deployment hardware, according to examples described herein. The model deployment system (MDS) can be implemented in software only, hardware only, or a combination of hardware and software. For example, as shown in FIG. 1, the MDS 102 comprises software components executed by one or more electronic computing devices. The components comprise a model registration subsystem 110, a model server 112, a Virtual Machine (VM) agent 114, a model inference accelerator (MIA) layer 116 and an inference container 128. The MDS 102 depicted in FIG. 1 is merely an example of an arrangement of components in a model deployment system. One of ordinary skill in the art would recognize many possible variations, alternatives, and modifications. For example, in some implementations, the MDS 102 may have more or fewer systems or components than those shown in FIG. 1, may combine two or more subsystems, or may have a different configuration or arrangement of subsystems.

In some examples, the components of the MDS 102 are provided by a cloud provider network (e.g., as part of a shared computing resource environment). In other examples, the components of the MDS 102 execute on computing devices managed within an on-premises datacenter or other computing environment, or on computing devices located within a combination of cloud-based and on-premises computing environments. For instance, users of an enterprise may utilize the functionality of the MDS 102 to dynamically generate an optimized machine learning (ML) model that is tailored to specific target deployment hardware on which the ML model is designed to run. In some other embodiments, the MDS 100 may be implemented on one or more servers of a cloud service provider (CSP) and its dynamic model optimization functionality may be provided to subscribers (e.g., an organization or an enterprise) who subscribe to cloud services on a subscription basis.

The MDS 102 broadly enables users to create model deployments by preparing a model (e.g., a ML model) for usage in a production environment. For instance, the MDS 102 can obtain a trained ML model, save the trained ML model in a format suitable for deployment, select a suitable target environment for deploying the model, deploy the ML model to the target environment and create an endpoint or other interface for users to interact with the model for predictions. Users associated with the MDS 102 (sometimes referred to herein as “model developers”) can use a computing device 106 to interact with the MDS 102 to perform operations relative to model deployments for which they are responsible. Although only one user is depicted in the example of FIG. 1, in general, any number of users can concurrently use the MDS 102 to create and manage any number of model deployments in a production environment. The computing device 106 may be communicatively coupled to the MDS 100, possibly via one or more communication networks. The computing device 106 may be of various types, including but not limited to, a mobile phone, a tablet, a desktop computer, and the like. The computing device 106 can communicate with the MDS 102 in a variety of ways such as, for example, over an internet protocol via a web browser or other application, via a command line interface, via a software developer kit (SDK), via a set of APIs and the like.

In FIG. 1, the steps numbered “1-10” illustrate a high-level process used by the MDS to create a model deployment and generate an optimized model that is tailored to target deployment hardware used for deploying the model in a target environment. While the numbers are sequential, in practice, the steps can be performed in any order and/or in parallel with one another. In some examples, as shown in FIG. 1, in step (1) of the model deployment process, a user 104 may interact with the MDS 102 to create a model deployment by specifying details of a model (e.g., a machine learning (ML) model) to be deployed using the MDS. For instance, the user can utilize an API (e.g., a create model deployment API) to create a model deployment with the MDS. The API may be provided by a model registry subsystem 110 within the MDS 102 and accessed by the user via an application or a web interface (e.g., a model registration UI 108), an SDK, or a command line interface of the computing device.

Using the create model deployment API, the user can identify the ML model to be registered with the MDS for deployment and specify metadata (descriptive information) about the ML model such as the type of ML model (e.g., a neural network (NN) model, a reinforcement learning (RL) model and so on), the model name, the model version number, the storage location where the model is located, and the type of ML model framework (e.g., TensorFlow, PyTorch and so on) used to create and train the ML model and so on. In certain embodiments, as part of model registration, the user may additionally specify custom metadata associated with the model to be deployed. The custom metadata may identify the target hardware (e.g., a target device) where the model is to be deployed, the type of model compiler used by the MDS to compile the model, a type of optimization to be performed by the model and so on.

In certain examples, as part of creating a model deployment, the user 104 may also set up a running environment on a model server 112 where the trained ML model can be used to make predictions on new data. For example, in step (2) of the model deployment process, a user 104 may interact with the MDS 102 to specify details related to the specific running environment where an instance of the model (also referred to herein as a “workload instance” or “model instance”) will be deployed and used to perform predictions. For instance, the user 104 can send a request to the MDS 102 to create a workload instance via an API call (e.g., a create workload instance API) to the MDS. Using the API call, the user 104 can specify a model deployment platform (e.g., a target device or a cloud service provider) for deploying the model, select a server instance (e.g., a virtual machine (VM)) with appropriate Central Processing Unit (CPU), memory, and Graphical Processing Unit (GPU) capacity based on the expected model workload, set up the necessary model libraries to load and serve the model and containerize the model (e.g., by creating a Docker file to encapsulate the model, dependencies and execution environment) for easier deployment and management. Responsive to the request, at step (2), the MDS 102 automatically provisions a model server 112 (i.e., a containerized environment (VM)) for the model that can be used to serve predictions for the model.

In certain examples, the model server 112 provisioned by the MDS 102 may comprise a Virtual Machine (VM) agent 114 that can be installed directly onto the model server 112 during its creation or after provisioning the model server. The VM agent 114 is responsible for orchestrating the setup of deployment resources for the model instance onto the VM by installing the necessary model dependencies, managing the model file (e.g., model configuration file), setting up the running environment on the model server 112 where the trained model can be used to make predictions. At step (3) of the model deployment process, the MDS 102 registers and uploads the ML model to a model catalog 124 (e.g., a model registry) of the MDS. The model catalog 124 is a centralized repository where information about different machine learning models that are built using different model frameworks are stored and organized, allowing users of the MDS to easily discover, access, and manage various models developed by the users.

In step (4) of the model deployment process, the VM agent 114 initiates the model optimization process by downloading the ML model to be optimized from the model catalog 124. For example, the ML model to be optimized may identify the ML model specified by the user during the model registration process at step (1). The VM agent 114 bootstraps an instance of the model onto the model server 112 by pre-loading necessary model components like model dependencies, model configuration files, and data onto the model instance.

At step (5) of the model deployment process the VM agent 114 saves the model instance 118 (also referred to herein as the “original ML model”) to a data store 114 associated with the model server 112. The data store 114 represents a dedicated storage space allocated within the model server 112 where the ML model can be stored and accessed for prediction purposes, essentially acting as the “home” for the model file on the virtualized computing environment, allowing it to be readily available for inference tasks when needed. The data storage 114 can be part of the server's primary disk or a separate data disk depending on the deployment setup.

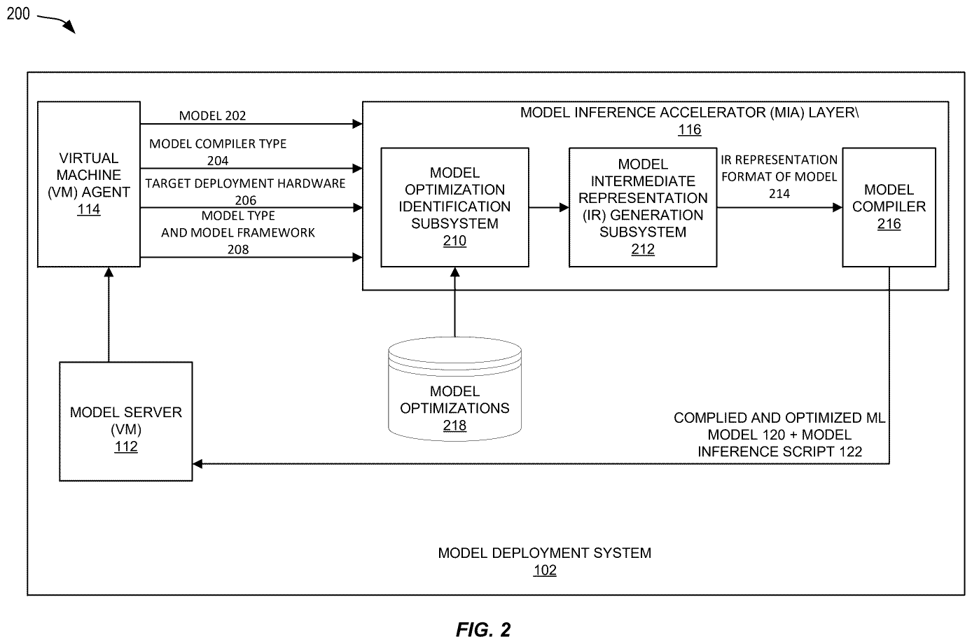

At step (6), the VM Agent 114 triggers the model optimization process by sending a request to the MIA layer 116 to perform model optimization. Upon receiving the request, the MIA layer 116 obtains and inspects the model metadata associated with the ML model (e.g., obtained as part of the model registration step (1)) from the VM agent, determines the appropriate model optimizations to be applied to the ML model and then generates an optimized ML model that is tailored to the target deployment hardware for deploying the ML model, based on the model optimizations. Details of the processing performed by the MIA to generate an optimized ML model is described in FIG. 2.

FIG. 2 is a diagram illustrating additional details of a model inference accelerator (MIA) layer used by the MDS to generate an optimized ML model that is tailored to target deployment hardware for deploying an ML model in a target environment, according to some examples. The MIA layer 116 may be implemented using one or more computing systems. For example, the computing systems may execute computer-readable instructions (e.g., code, program) to implement the MIA layer 116. As depicted in FIG. 2, the MIA layer 116 includes various computing systems including a model optimization identification subsystem 210, a model intermediate representation (IR) generation subsystem 212 and a model compiler 216. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

According to certain examples described herein, the model optimization process is triggered by the MIA layer 116 when the MIA layer 116 receives input from the VM agent 114 that identifies the ML model 202 to be optimized along with metadata associated with the ML model. In certain examples, a model optimization identification subsystem 210 in the MIA layer 116 receives the model metadata. The model metadata can include, for example, the type of model compiler 204 used by the MDS for compiling the ML model, the target deployment hardware 206 for deploying the ML model, the model type (e.g., a NN model, a RL model and so on) to be optimized and the specific model framework (e.g., PyTorch, TensorFlow and so on) 208 used for building and training the ML model.

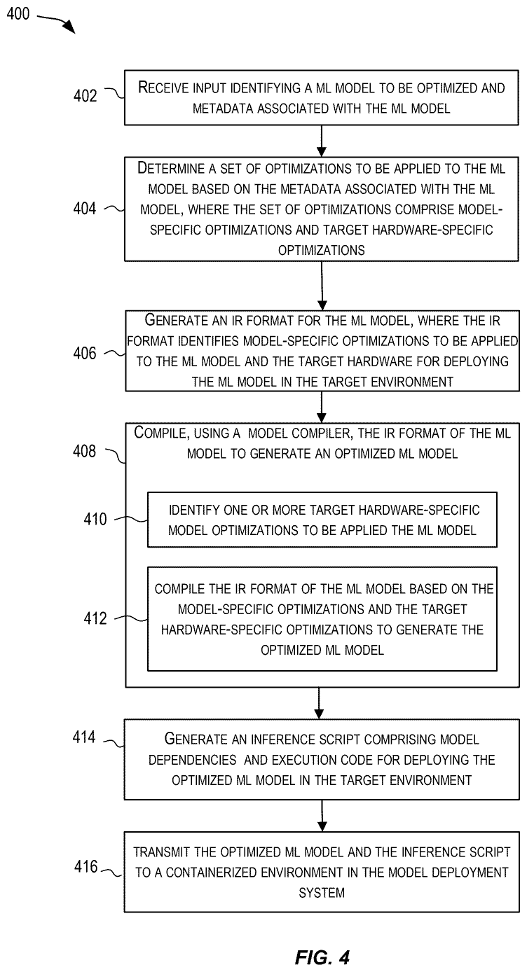

Based on the specified model metadata, the model optimization identification subsystem 210 determines a set of optimizations that can be applied to the ML model by accessing information related to the set of optimizations stored in a database or other datastore (e.g., 218) accessible to the MIA layer. As described in more detail hereinafter, the set of optimizations that can be identified by the model optimization identification subsystem 210 can include model-specific optimizations and target hardware-specific optimizations. Details related to the types of model optimizations identified by the model optimization identification subsystem 210 based on the model metadata specified for the ML model is further described in FIG. 4.

The identified ML model 202, the model metadata (e.g., 204, 206 and 208) along with the model-specific optimizations and target hardware-specific optimizations identified by the model optimization identification subsystem 210 are then provided to a model intermediate representation (IR) generation subsystem 212 within the MIA layer 116. The model IR generation subsystem 212 generates an IR format for the identified ML model. The IR format for the ML model represents a data structure used to represent the ML model in a standardized format. The conversion of the ML model into an IR format facilitates various optimizations to be applied to the ML model across various target deployment platforms without needing to modify the original model architecture (i.e., the particular framework, Pytorch framework, a Tensorflow framework and so on) used for building and training the ML model.

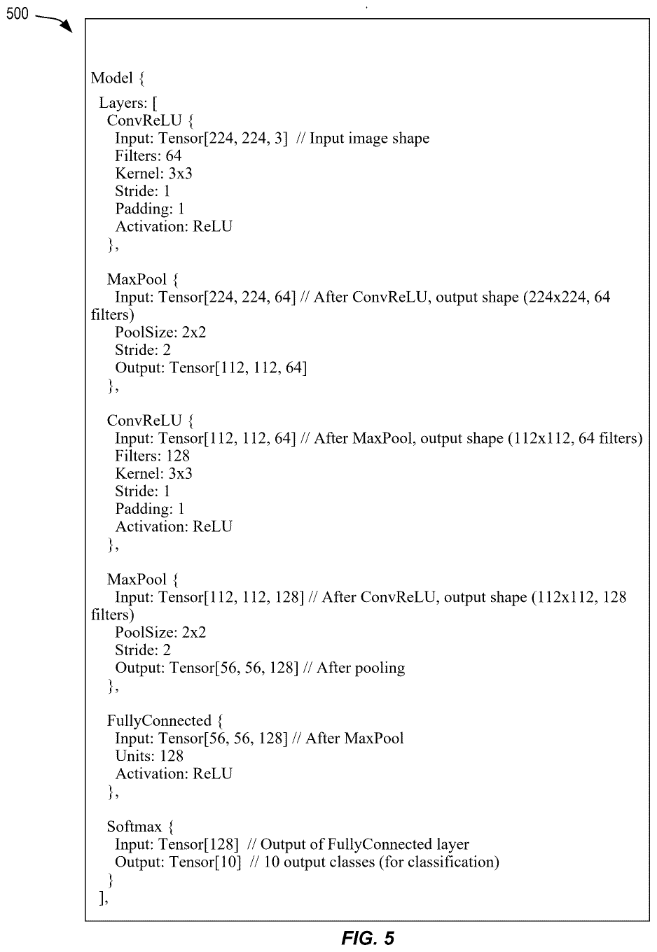

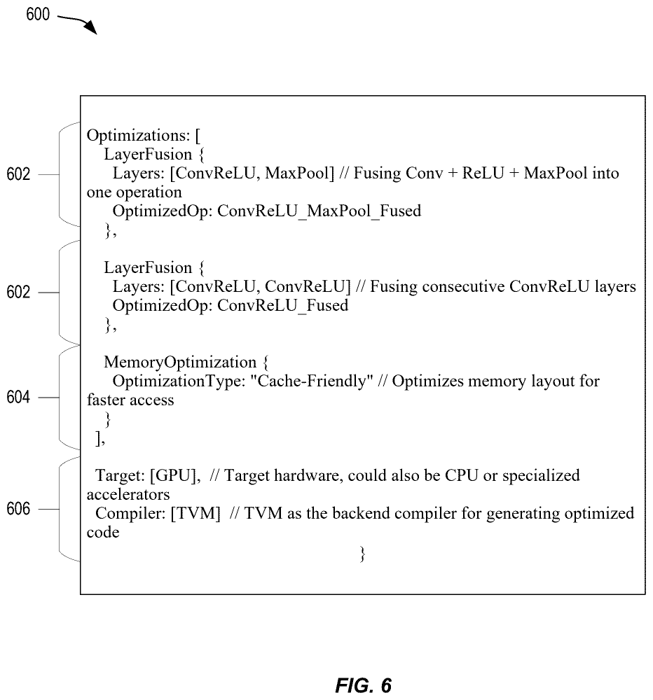

In certain examples, the IR format of the ML model 214 identifies model components of the ML model, the model-specific optimizations to be applied to the ML model and the target hardware for deploying the ML model to a target environment. An example of the IR format generated for a ML model is shown in FIG. 5 and FIG. 6. Upon generating the IR format 214 of the ML model, the MIA layer 116 subsequently invokes a model compiler 216 to compile the IR format 214 of the ML model based on the model-specific optimizations and target hardware-specific optimizations to generate an optimized ML model that is tailored to target deployment hardware used for deploying the ML model in a target environment. In certain examples, the model compiler 216 implemented by the MIA layer may represent an open-source compiler such as a Tensor Virtual Machine (TVM) compiler that includes capabilities to compile the IR of the model 214 and perform optimization tailored to the targeted deployment hardware to generate an optimized ML model (e.g., 120). Details related to the processing performed by the model compiler 216 to compile the IR format of the ML model to generate an optimized ML model is further described in FIG. 4.

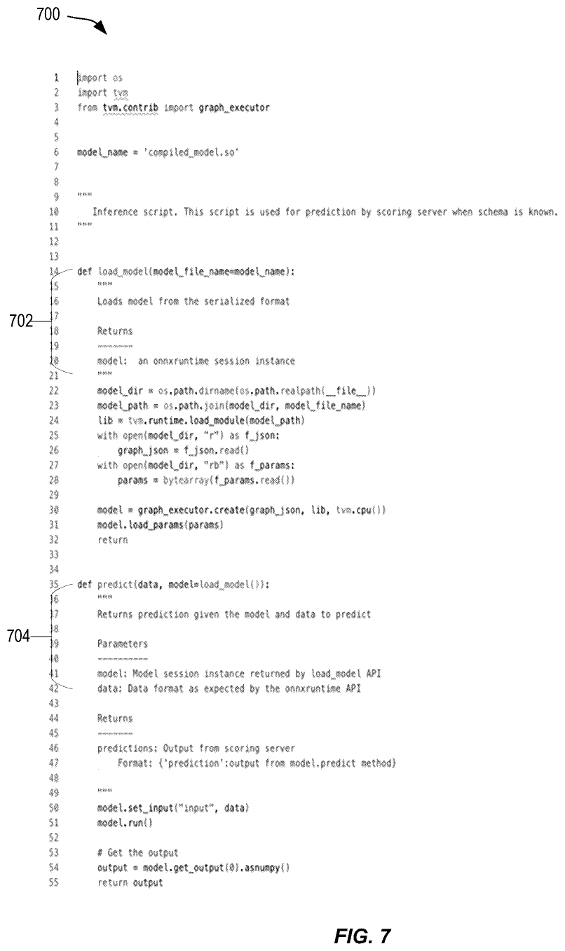

In certain examples, as part of the model optimization process, the model compiler 216 also automatically generates an executable model inference script (e.g., 122) to streamline the model deployment process. The model inference script handles the process of making predictions using the compiled and optimized ML model (e.g., 120). The model inference script 122 utilizes relevant libraries to load and interact with the ML model depending on the type of ML framework (e.g., TensorFlow, PyTorch and so on) used to build and train the ML model. The model inference script is additionally structured to handle hardware specifics of the target device such as CPU, GPU, or deployment accelerators, and is tasked with managing inference tasks efficiently. According to examples described herein, the model inference script can be implemented as a Python file that encapsulates functions for the ML model for performing loading and prediction. An example of a model inference script generated by the MIA layer is further described in FIG. 7.

Returning to the discussion of FIG. 1, at step (7) of the model deployment process, the MIA layer 116 saves the optimized ML model 120 and the model inference script 122 to the data store 114 of the model server 112. At step (8) of the model deployment process, the model server 112 mounts the entire compilation environment (i.e., the optimized ML model 120 and the model inference script 122) to an inference container 128 in the MDS 102. The model inference container 128 may represent a Docker container that serves as a self-contained environment (containerized environment) for running model inference operations. The model inference container 128 packages the compiled and optimized ML model, along with its necessary dependencies and the model inference script in an inference container image 130. The inference container image 130 is then deployed to a target device 132 where the model is designed to run and generate predictions on new data.

In step (9) of the model deployment process, once the model 120 is running within the container image 130, it is capable of loading the inference script immediately, thus enabling it to handle inference requests with minimal delay. The container image 130 exposes an inference endpoint to receive new data from users of the MDS for prediction. When a new data point is sent (e.g., by a user 104 of the MDS via computing device 106) to the container image 130, the container image 130 executes the model inference script to generate a prediction (inference) result at step (10) based on the optimized ML model.

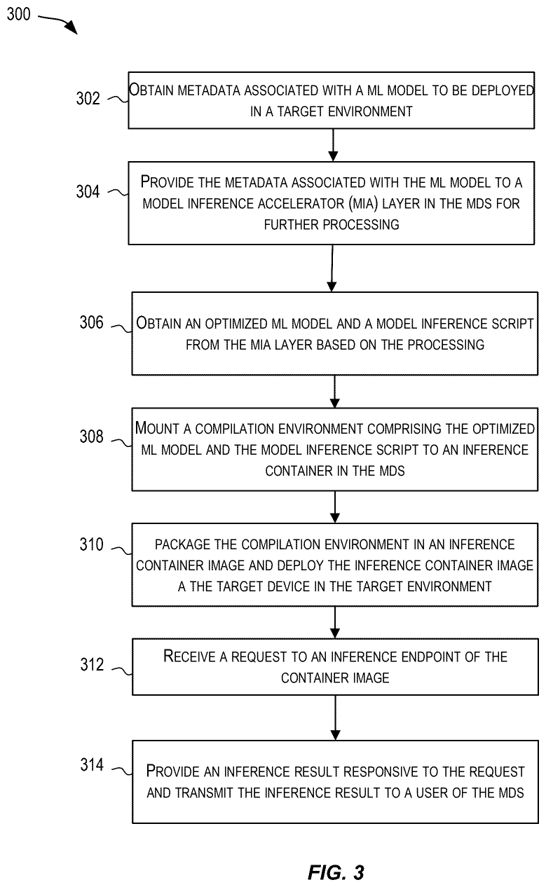

FIG. 3 is a simplified flowchart 300 depicting the processing performed by the subsystems of the MDS 102 shown in FIG. 1 for generating an optimized ML model, according to certain embodiments. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 1, the processing depicted in FIG. 3 may be performed by the subsystems (110, 114, 116, 112 and 128) of the MDS 102 described in FIG. 1.

In the embodiment depicted in FIG. 3, processing may be initiated at block 302 when the model registration subsystem 110 obtains metadata associated with a ML model to be deployed in a target environment. Model metadata may include, but is not limited to, the model name, the model version number, the storage location where the model is located, and the type of ML model framework (e.g. TensorFlow, PyTorch and so on) used to create and train the ML model, the target hardware (e.g., a target device) where the model is to be deployed, the type of model compiler used by the MDS to compile the model, a type of optimization to be performed by the model and so on. For instance, as described in FIG. 1, a user of the MDS can interact with the model registration subsystem 110 via one or more APIs to provide the model metadata as part of creating a model deployment.

At block 304, the model metadata is provided to the MIA layer 116 in the MDS for further processing. For instance, as previously described, the model metadata may be provided to the MIA layer 116 by a VM Agent 114 in the MDS. Upon obtaining the model metadata, the MIA layer 116 inspects the model metadata and determines the appropriate model optimizations to be applied to the ML model and then generates an optimized ML model that is tailored to the target deployment hardware for deploying the ML model, based on the model optimizations. Details related to the processing performed by the MIA layer to generate an optimized ML model is further described in FIG. 4.

At block 306, the model server (e.g., 112) obtains the optimized ML model and a model inference script from the MIA layer. As previously described, the model inference script handles the process of making predictions using the compiled and optimized ML model. An example of a model inference script generated by the MIA layer is further described in FIG. 7.

At block 308, the model server 112 mounts a compilation environment comprising the optimized ML model and the model inference script to an inference container in the MDS. The model inference container (e.g., 128) may represent a Docker container that serves as a self-contained environment (containerized environment) for running model inference operations.

At block 310, the model inference container packages the compiled and optimized ML model, along with its necessary dependencies and the model inference script in an inference container image (e.g., 130) and deploys the inference container image to the target device in the target environment.

At block 312, the inference container image receives a request for prediction to an inference endpoint of the image.

At block 314, the container image executes the model inference script to generate a prediction (inference) result based on the optimized ML model and provides an inference result responsive to the request and transmits the inference result to a user of the MDS.

FIG. 4 is a simplified flowchart 400 depicting the processing performed by the subsystems of the MIA layer shown in FIG. 2 for generating an optimized ML model, according to certain embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order, or some steps may also be performed in parallel. In certain embodiments, such as in the embodiment depicted in FIG. 2, the processing depicted in FIG. 4 may be performed by the subsystems 210, 212 and 216 described in FIG. 2.

In the embodiment depicted in FIG. 4, processing may be initiated at block 402 when the model optimization identification subsystem 210 within the MIA layer 116 receives input from the VM agent 114 that identifies the ML model 202 to be optimized along with metadata associated with the ML model. For instance, as described in FIG. 2, the model metadata can include, for example, the type of model compiler 204 used by the MDS for compiling the ML model, the target deployment hardware 206 for deploying the ML model, the model type (e.g., a NN model, a RL model and so on) to be optimized and the specific model framework (e.g., PyTorch, TensorFlow and so on) 208 used for building and training the ML model.

At block 404, the model optimization identification subsystem 210 determines a set of optimizations to be applied to the ML model based on the metadata specified for the model. The set of optimizations may include model-specific optimizations as well as target hardware-specific optimizations and may be accessed by the subsystem 210 from a database or other datastore (e.g., 126) accessible to the subsystem 210. The model optimization identification subsystem may be configured to identify various model-specific optimizations and/or target hardware-specific optimizations for an ML model. Examples of different types of model-specific optimizations and target hardware-specific optimizations that may be identified for an ML model are described in the section titled “model optimizations” below.

### Model Optimizations

In certain examples, the model optimization identification subsystem 210 may identify an operator layer fusion (a type of model-specific optimization) to be applied to the ML model based on the type of ML model and based on the type of target deployment hardware identified for deploying the ML model. For instance, if the type of ML model is a Neural Network (NN) and the ML model is going to be deployed on target hardware architecture (e.g., GPUs), the model optimization identification subsystem 210 may identify that “operator layer fusion” should be applied to the ML model. “Operator layer fusion” refers to the technique of combining multiple consecutive mathematical operations (operators) within a neural network into a single operation, effectively reducing the need for intermediate memory storage and improving computational efficiency by performing calculations together instead of separately. For instance, in a NN, layers with unused output can be eliminated to avoid unnecessary computation, certain layers (e.g., certain convolutional layers, batch norm layers, bias layers, and/or ReLU activation layers) can be combined or “fused” together to form a single layer, layers can be combined layers via layer aggregation that take a same source tensor and apply the same operations with similar parameters to result in a single larger layer for higher computational efficiency.

As another example, the model optimization identification subsystem 210 may identify a “constant folding” model optimization technique to be applied to an ML model based on the type of ML model and based on the type of target deployment hardware identified for deploying the ML model. “Constant folding optimization” refers to an optimization technique where a machine learning model's computational graph is analyzed to identify and pre-calculate expressions that only involve constant values, replacing them with the computed result at compile time, thereby reducing the number of operations needed during runtime. By pre-computing constant expressions, the model spends less time on redundant calculations, leading to improved inference speeds.

In other examples, the model optimization identification subsystem 210 may identify a “quantization” optimization technique to be applied to an ML model based on the type of ML model and based on the type of target deployment hardware identified for deploying the ML model. “Quantization” refers to a technique that reduces the precision of a model's weights and activations, typically by converting them from high-precision floating-point values (like 32-bit) to lower-precision data types (like 8-bit integers), resulting in a smaller model size and faster inference speed, making it ideal for deploying models on resource-constrained target devices such as mobile phones.

According to examples described herein, in addition to the model-specific optimizations described above, the model optimization identification subsystem 210 may identify various target hardware-specific optimizations (e.g., “warp level parallelism” optimization or “shared memory” optimization) to be applied to the ML model based on the inference target hardware (e.g., CPU, GPU) specified as part of the model metadata. For instance, “warp level parallelism” refers to an optimization technique that leverages the parallel processing capabilities of the type of target deployment hardware (e.g., a GPU) by dividing computation into small units called “warps” (typically containing 32 threads), where all threads within a warp execute the same instruction simultaneously, allowing for highly efficient parallel processing on large datasets used in model training and optimization. “Shared memory optimization” refers to a technique that leverages shared memory to improve the efficiency of training and inference processes by allowing multiple threads or processes within a system to access and modify data simultaneously, leading to faster computation and reduced memory usage, especially when dealing with the deployment of models on target multi-core architectures such as GPUs.

In other examples, the model optimization identification subsystem 210 may identify target hardware-specific optimization techniques such as “parallelization” or “vectorization” to be applied to the ML model based on the inference target hardware specified as part of the model metadata. “Parallelization” refers to distributing computations across multiple CPU cores or GPUs to perform calculations simultaneously. When large amounts of data need to be processed, splitting the workload across multiple cores can significantly reduce computation time. “Vectorization” refers to a technique that leverages specialized instructions to process multiple data elements in parallel within a single core, essentially performing operations on “vectors” of data instead of single values, leading to significant performance gains.

In certain embodiments, the model optimization identification subsystem 210 may implement a plurality of optimization rules to determine a particular type of optimization (e.g., model-specific optimization or target hardware-specific optimization) to be applied to the ML model. Examples of such optimization rules are listed below. The examples of the optimization rules listed below are just some examples of rules that may be implemented by the model optimization identification subsystem. In other examples, the model optimization identification subsystem may implement other types of target hardware-specific optimization rules and model-specific optimization rules on an ML model.
Rule 1: If the target deployment hardware is a GPU, then apply a target hardware-specific optimization to break down large tensor computations into smaller blocks that fit into shared memory, thereby reducing global memory accesses and improving the computational efficiency.
Rule 2: If the target deployment hardware is a GPU or a CPU, then perform vectorization that enables Single Instruction Multiple Data (SIMD) execution, allowing a processor to perform the same operation on multiple data points simultaneously, leveraging hardware-specific vector instructions such as Advanced Vector Extensions (AVX), Streaming SIMD Extensions (SSE) (on x86 CPUs), NEON (on ARM CPUs), or Compute Unified Device Architecture (CUDA) warp-level parallelism.
Rule 3: If target hardware is a GPU, then apply a target hardware-specific optimization to perform thread binding to efficiently map computations onto hardware threads, thereby ensuring efficient parallel execution.

At block 406, the identified ML model along with the model-specific optimizations and target hardware-specific optimizations identified by the model optimization identification subsystem 210 are provided to a model intermediate representation (IR) generation subsystem 212 within the MIA layer which then generates an IR format of the model. The IR format of the ML model (e.g., 214) identifies model components of the ML model, the model-specific optimizations to be applied to the ML model and the target hardware for deploying the ML model to a target environment. An example of the IR format generated for a ML model is illustrated in FIG. 5 and FIG. 6 and described below.

### Intermediate Representation (IR) Format for a ML Model

FIG. 5 illustrates an example of an intermediate representation (IR) format for a machine learning (ML) model that is generated by the Model Inference Accelerator (MIA) layer shown in FIG. 1, according to certain embodiments. As previously described, the IR format represents an abstract, hardware-agnostic representation of the ML model. This intermediate format allows for optimizations to be applied before the model is compiled for the specific target hardware (CPU, GPU, deployment accelerators.). In certain implementations, the IR format for an ML model identifies a set of model components of the ML model, the model-specific optimizations to be applied to the ML model and the target hardware for deploying the ML model to a target environment. In the example implementation shown in FIG. 5, the IR format 500 for the ML model identifies a set of model components for a Convolutional Neural Network (CNN). The set of model components for a CNN represent a set of layers within the CNN. For purposes of describing this example, the set of layers may include an input layer that receives data from the outside world, a set of hidden layers that are intermediary layers between the input and output and perform functions like data transformation and automatic feature extraction and an output layer that holds the result or output of the problem.

In the example of illustrated in FIG. 5 the IR format for the ML model (i.e., a CNN) identifies a set of layers of a CNN that is configured to perform image recognition. The set of layers include an input layer that accepts an input image (e.g., a 224×224 RGB image RGB image), a set of hidden layers that include a convolutional layer (Conv1 with 64 filters, 3×3 kernel, ReLU activation) that applies filters to the input image to detect basic features (e.g., edges, textures) and a ReLU Activation layer that applies a non-linear activation function to the output of Conv1. The set of hidden layers additionally include a MaxPooling Layer (MaxPool1 with a 2×2 kernel, stride 2) that reduces the spatial dimensions (down sampling) of the output from the previous layers, a Convolutional Layer (Conv2 with 128 filters, 3×3 kernel, ReLU activation) that learns more complex features from the output of the pooling layer, a ReLU Activation Layer that applies ReLU again to the Conv2 output, a Fully Connected Layer (FC1 with 128 units, ReLU activation) and a Fully Connected Layer (FC2 with 10 units (output classes), softmax activation) that flattens the output from the previous layers and applies weights to connect to the output layer. The output layer produces the final classification output (e.g., probabilities for each class). The IR format illustrated in FIG. 5 is just one example of IR format generated by the MIA layer for CNN. In other examples, the MIA layer may generate an IR format for a CNN that includes more or fewer numbers of layers of a CNN.

In certain implementations, and as illustrated in FIG. 6, the IR format 500 for a ML model additionally identifies model-specific optimizations to be applied to the ML model and the target hardware for deploying the ML model in a target environment. FIG. 6 illustrates another example of an intermediate representation (IR) format for a machine learning (ML) model that is generated by the Model Inference Accelerator (MIA) layer shown in FIG. 1, according to certain embodiments. According to examples described herein, the IR format 600 depicted in FIG. 6 may be included as part of the IR format 500 of the ML model (i.e., a NN) described in FIG. 5. As illustrated in FIG. 6, the IR format 600 of the CNN identifies a layer fusion optimization 602 that may be applied to one or more layers of the CNN. In the illustrated example, the layer fusion optimization 602 is used to combine or “fuse” together the Conv, ReLU and MaxPool layers of the CNN into a single operation. The layer fusion optimization 602 additionally combines (fuses) consecutive ConvReLu layers into a single operation. Fusing one or more layers of the CNN effectively reduces the need for intermediate memory storage and improves computational efficiency by performing calculations together instead of separately.

The example of the IR format for the CNN illustrated in FIG. 6 additionally identifies a memory layout optimization that can be applied to the CNN. A “memory layout optimization” refers to strategically arranging the data within a ML model's tensors to maximize computational efficiency by minimizing unnecessary memory accesses and data movement. By organizing data in a way that aligns with the memory access pattern, the need to fetch data from different memory locations is minimized, improving inference performance. For example, in the context of a CNN, memory layout optimization can be applied to optimize the layout of filter weights to perform convolution operations. The IR format 600 also identifies the target hardware platform (e.g., GPU, CPU or specialized accelerators) for deploying the CNN and the type of model compiler (TVM) used for generating optimized code (i.e., an optimized model) based on the IR format of the model. The IR format 600 illustrated in FIG. 6 is just one example of IR format generated by the MIA layer for a CNN. In other examples, the MIA layer may generate an IR format for a CNN that includes more or fewer number of model optimizations or other types of optimizations (e.g., memory efficient attention techniques such as flash attention) to be applied to a CNN.

Returning to the discussion of FIG. 4, at block 408, the IR format of the ML model is compiled to generate an optimized ML model. In certain examples, a model compiler (e.g., 216) in the MIA layer compiles the IR format of the ML model by applying the model-specific optimizations and the target hardware-specific optimizations (identified in block 404) to generate an optimized ML model that is tailored to target deployment hardware used for deploying the ML model in a target environment. In certain examples, the type of model complier used by the MIA layer to generate an optimized ML model may be specified as part of the model metadata (e.g., as part of metadata 204).

Various types of ML model compilers may be utilized by the MIA layer to perform model optimizations specific to different target hardware architectures. According to examples described herein, the MIA layer may utilize a Tensor Virtual Machine (TVM) model compiler to generate an optimized ML model. The TVM model compiler enables model developers to optimize and deploy ML models across a wide variety of target hardware platforms (e.g., CPUs, GPUs, and specialized accelerators), by automatically generating efficient code tailored to the target device. The TVM model compiler can compile models built using various frameworks (TensorFlow, PyTorch and so on) and deploy them on different target devices with different hardware capabilities without requiring significant code changes. In other examples, other types of model compilers can also be used to generate compiled code that best aligns with the identified target deployment hardware such as LLVM (Low Level Virtual Machine) which is a widely used open-source compiler infrastructure that provides a flexible platform for various optimizations and is often used by machine learning frameworks like TensorFlow and PyTorch, the Compute Unified Device Architecture (CUDA) compiler that is specialized for GPUs, allowing for efficient GPU-accelerated computation and so on.

In certain examples, the processing performed by the model compiler in block 408 may involve identifying, at block 410, the target hardware-specific optimizations to be applied to the ML model and compiling, at block 412, the IR format of the ML model based on the set of optimizations (e.g., the model-specific optimizations and the target hardware-specific optimizations) to generate an optimized ML model. For example, if the “operator fusion” model optimization technique is applied to the ML model, then the model compiler (e.g., TVM) can include capabilities to fuse separate layers in the NN model into a single layer during model compilation. For instance, the model compiler can fuse the layers (conv2D->batch-form->relu) into a single layer to reduce the number of memory accesses, thereby improving the inference (runtime) efficiency of the model.

As another example, when specific target hardware-specific optimizations are identified based on the target deployment hardware, the underlying TVM compiler may be configured to apply optimizations specific to that hardware. For instance, on GPAs, it can leverage warp-level parallelism and shared memory to speed up computation. In another example, the TVM compiler may be configured to parallelize operations where possible, taking advantage of multiple CPU or GPU cores. The TVM compiler may also apply vectorization to enable operations to run in parallel within a single core.

At block 414, the model compiler generates an inference script comprising model dependencies and execution code for deploying the ML model in a target environment. An example of an inference script generated by the model compiler is further described in FIG. 7.

At block 416, the model compiler transmits the optimized ML model and the model inference script to a containerized environment (e.g., a model sever 112) in the model deployment system. As previously noted, the model inference script handles the process of making predictions using the compiled and optimized ML model (e.g., 120). According to examples described herein, the model inference script can be implemented as a Python file that encapsulates functions for the ML model for performing loading and prediction. An example of a model inference script generated by the MIA layer is further described in FIG. 7.

FIG. 7 illustrates an example of a model inference script that is generated by the Model Inference Accelerator (MIA) layer shown in FIG. 1, according to certain embodiments. In the example of illustrated in FIG. 7 the model inference script encapsulates functions for the ML model for performing loading and prediction. For instance, the load API function (e.g., load_model function) within the script manages the intricacies of loading the compiled and optimized ML model onto the target hardware so that it can be used for making predictions. Depending on the target inference hardware (e.g., CPU, GPU), the “load_model” function 702 can configure the model to run on the appropriate target device. The Predict API function 704 ensures streamlined execution once the ML model is active and used for inferencing. This function takes input data, runs it through the optimized ML model, and returns the predicted output based on the model's analysis, allowing users to use the optimized ML model to make predictions on new data in a structured way.

The MDS described in the present disclosure provides several technical advancements and/or improvements over conventional model deployment processes by facilitating efficient model optimization targeted to specific deployment hardware. The MDS disclosed herein is capable of dynamically optimizing a ML model based on the constraints and specific capabilities of a target device used to deploy the ML model by applying model-specific optimizations and target hardware-specific model optimizations to the ML model. The MDS efficiently and accurately performs model optimization by using an abstraction layer that is provided as part of the MDS. The abstraction layer can be implemented by a “model inference accelerator (MIA) layer” within the model deployment system. The MIA layer performs model optimization by inspecting model metadata associated with the ML model and determining the appropriate optimization strategy to be applied to the model based on the model metadata and based on information identifying a target hardware for deploying the ML model in a target environment.

In certain examples, the MIA layer generates an intermediate representation (IR) format for the ML model and applies model-specific optimizations and target hardware-specific optimizations to the ML model. The MIA layer compiles the IR format of the model based on the model-specific optimizations and the target hardware-specific optimizations to generate an optimized ML model that is optimized for specific target deployment hardware used to deploy the ML model. The MIA described herein additionally includes capabilities to take into consideration the hardware specifications of different target device and perform target hardware-specific optimization based on the constraints and capabilities of the target device. By optimizing the ML model for specific target deployment hardware, the MIA described herein can significantly improve the speed and efficiency of performing model inferences.

### Examples of Cloud Infrastructure

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

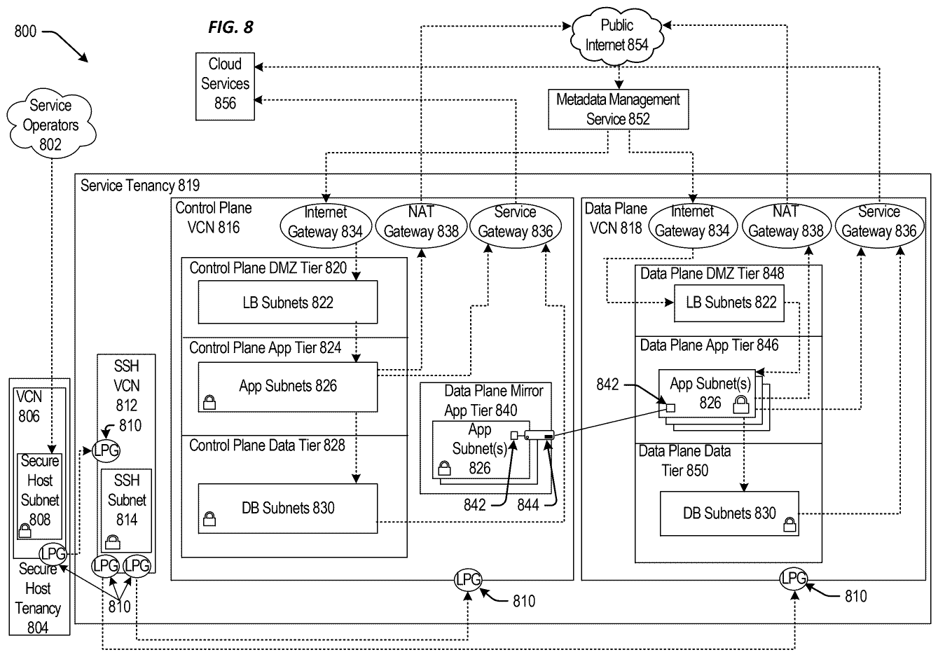

FIG. 8 is a block diagram 800 illustrating an example pattern of an IaaS architecture, according to at least one embodiment. Service operators 802 can be communicatively coupled to a secure host tenancy 804 that can include a virtual cloud network (VCN) 806 and a secure host subnet 808. In some examples, the service operators 802 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 806 and/or the Internet.

The VCN 806 can include a local peering gateway (LPG) 810 that can be communicatively coupled to a secure shell (SSH) VCN 812 via an LPG 810 contained in the SSH VCN 812. The SSH VCN 812 can include an SSH subnet 814, and the SSH VCN 812 can be communicatively coupled to a control plane VCN 816 via the LPG 810 contained in the control plane VCN 816. Also, the SSH VCN 812 can be communicatively coupled to a data plane VCN 818 via an LPG 810. The control plane VCN 816 and the data plane VCN 818 can be contained in a service tenancy 819 that can be owned and/or operated by the IaaS provider.

The control plane VCN 816 can include a control plane demilitarized zone (DMZ) tier 820 that acts as a perimeter network (e.g., portions of a corporate network between the corporate intranet and external networks). The DMZ-based servers may have restricted responsibilities and help keep breaches contained. Additionally, the DMZ tier 820 can include one or more load balancer (LB) subnet(s) 822, a control plane app tier 824 that can include app subnet(s) 826, a control plane data tier 828 that can include database (DB) subnet(s) 830 (e.g., frontend DB subnet(s) and/or backend DB subnet(s)). The LB subnet(s) 822 contained in the control plane DMZ tier 820 can be communicatively coupled to the app subnet(s) 826 contained in the control plane app tier 824 and an Internet gateway 834 that can be contained in the control plane VCN 816, and the app subnet(s) 826 can be communicatively coupled to the DB subnet(s) 830 contained in the control plane data tier 828 and a service gateway 836 and a network address translation (NAT) gateway 838. The control plane VCN 816 can include the service gateway 836 and the NAT gateway 838.

The control plane VCN 816 can include a data plane mirror app tier 840 that can include app subnet(s) 826. The app subnet(s) 826 contained in the data plane mirror app tier 840 can include a virtual network interface controller (VNIC) 842 that can execute a compute instance 844. The compute instance 844 can communicatively couple the app subnet(s) 826 of the data plane mirror app tier 840 to app subnet(s) 826 that can be contained in a data plane app tier 846.

The data plane VCN 818 can include the data plane app tier 846, a data plane DMZ tier 848, and a data plane data tier 850. The data plane DMZ tier 848 can include LB subnet(s) 822 that can be communicatively coupled to the app subnet(s) 826 of the data plane app tier 846 and the Internet gateway 834 of the data plane VCN 818. The app subnet(s) 826 can be communicatively coupled to the service gateway 836 of the data plane VCN 818 and the NAT gateway 838 of the data plane VCN 818. The data plane data tier 850 can also include the DB subnet(s) 830 that can be communicatively coupled to the app subnet(s) 826 of the data plane app tier 846.

The Internet gateway 834 of the control plane VCN 816 and of the data plane VCN 818 can be communicatively coupled to a metadata management service 852 that can be communicatively coupled to public Internet 854. Public Internet 854 can be communicatively coupled to the NAT gateway 838 of the control plane VCN 816 and of the data plane VCN 818. The service gateway 836 of the control plane VCN 816 and of the data plane VCN 818 can be communicatively couple to cloud services 856.

In some examples, the service gateway 836 of the control plane VCN 816 or of the data plane VCN 818 can make application programming interface (API) calls to cloud services 856 without going through public Internet 854. The API calls to cloud services 856 from the service gateway 836 can be one-way: the service gateway 836 can make API calls to cloud services 856, and cloud services 856 can send requested data to the service gateway 836. But, cloud services 856 may not initiate API calls to the service gateway 836.

In some examples, the secure host tenancy 804 can be directly connected to the service tenancy 819, which may be otherwise isolated. The secure host subnet 808 can communicate with the SSH subnet 814 through an LPG 810 that may enable two-way communication over an otherwise isolated system. Connecting the secure host subnet 808 to the SSH subnet 814 may give the secure host subnet 808 access to other entities within the service tenancy 819.

The control plane VCN 816 may allow users of the service tenancy 819 to set up or otherwise provision desired resources. Desired resources provisioned in the control plane VCN 816 may be deployed or otherwise used in the data plane VCN 818. In some examples, the control plane VCN 816 can be isolated from the data plane VCN 818, and the data plane mirror app tier 840 of the control plane VCN 816 can communicate with the data plane app tier 846 of the data plane VCN 818 via VNICs 842 that can be contained in the data plane mirror app tier 840 and the data plane app tier 846.

In some examples, users of the system, or customers, can make requests, for example create, read, update, or delete (CRUD) operations, through public Internet 854 that can communicate the requests to the metadata management service 852. The metadata management service 852 can communicate the request to the control plane VCN 816 through the Internet gateway 834. The request can be received by the LB subnet(s) 822 contained in the control plane DMZ tier 820. The LB subnet(s) 822 may determine that the request is valid, and in response to this determination, the LB subnet(s) 822 can transmit the request to app subnet(s) 826 contained in the control plane app tier 824. If the request is validated and requires a call to public Internet 854, the call to public Internet 854 may be transmitted to the NAT gateway 838 that can make the call to public Internet 854. Metadata that may be desired to be stored by the request can be stored in the DB subnet(s) 830.

In some examples, the data plane mirror app tier 840 can facilitate direct communication between the control plane VCN 816 and the data plane VCN 818. For example, changes, updates, or other suitable modifications to configuration may be desired to be applied to the resources contained in the data plane VCN 818. Via a VNIC 842, the control plane VCN 816 can directly communicate with, and can thereby execute the changes, updates, or other suitable modifications to configuration to, resources contained in the data plane VCN 818.

In some embodiments, the control plane VCN 816 and the data plane VCN 818 can be contained in the service tenancy 819. In this case, the user, or the customer, of the system may not own or operate either the control plane VCN 816 or the data plane VCN 818. Instead, the IaaS provider may own or operate the control plane VCN 816 and the data plane VCN 818, both of which may be contained in the service tenancy 819. This embodiment can enable isolation of networks that may prevent users or customers from interacting with other users', or other customers', resources. Also, this embodiment may allow users or customers of the system to store databases privately without needing to rely on public Internet 854, which may not have a desired level of threat prevention, for storage.

In other embodiments, the LB subnet(s) 822 contained in the control plane VCN 816 can be configured to receive a signal from the service gateway 836. In this embodiment, the control plane VCN 816 and the data plane VCN 818 may be configured to be called by a customer of the IaaS provider without calling public Internet 854. Customers of the IaaS provider may desire this embodiment since database(s) that the customers use may be controlled by the IaaS provider and may be stored on the service tenancy 819, which may be isolated from public Internet 854.

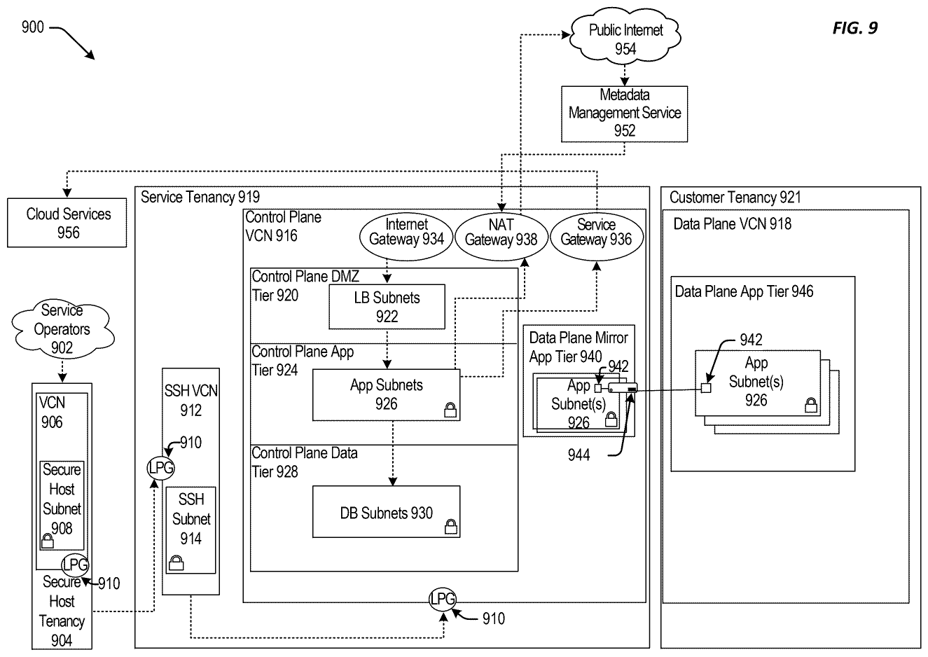

FIG. 9 is a block diagram 900 illustrating another example pattern of an IaaS architecture, according to at least one embodiment. Service operators 902 (e.g., service operators 802 of FIG. 8) can be communicatively coupled to a secure host tenancy 904 (e.g., the secure host tenancy 804 of FIG. 8) that can include a virtual cloud network (VCN) 906 (e.g., the VCN 806 of FIG. 8) and a secure host subnet 908 (e.g., the secure host subnet 808 of FIG. 8). The VCN 906 can include a local peering gateway (LPG) 910 (e.g., the LPG 810 of FIG. 8) that can be communicatively coupled to a secure shell (SSH) VCN 912 (e.g., the SSH VCN 812 of FIG. 8) via an LPG 810 contained in the SSH VCN 912. The SSH VCN 912 can include an SSH subnet 914 (e.g., the SSH subnet 814 of FIG. 8), and the SSH VCN 912 can be communicatively coupled to a control plane VCN 916 (e.g., the control plane VCN 816 of FIG. 8) via an LPG 910 contained in the control plane VCN 916. The control plane VCN 916 can be contained in a service tenancy 919 (e.g., the service tenancy 819 of FIG. 8), and the data plane VCN 918 (e.g., the data plane VCN 818 of FIG. 8) can be contained in a customer tenancy 921 that may be owned or operated by users, or customers, of the system.

The control plane VCN 916 can include a control plane DMZ tier 920 (e.g., the control plane DMZ tier 820 of FIG. 8) that can include LB subnet(s) 922 (e.g., LB subnet(s) 822 of FIG. 8), a control plane app tier 924 (e.g., the control plane app tier 824 of FIG. 8) that can include app subnet(s) 926 (e.g., app subnet(s) 826 of FIG. 8), a control plane data tier 928 (e.g., the control plane data tier 828 of FIG. 8) that can include database (DB) subnet(s) 930 (e.g., similar to DB subnet(s) 830 of FIG. 8). The LB subnet(s) 922 contained in the control plane DMZ tier 920 can be communicatively coupled to the app subnet(s) 926 contained in the control plane app tier 924 and an Internet gateway 934 (e.g., the Internet gateway 834 of FIG. 8) that can be contained in the control plane VCN 916, and the app subnet(s) 926 can be communicatively coupled to the DB subnet(s) 930 contained in the control plane data tier 928 and a service gateway 936 (e.g., the service gateway 836 of FIG. 8) and a network address translation (NAT) gateway 938 (e.g., the NAT gateway 838 of FIG. 8). The control plane VCN 916 can include the service gateway 936 and the NAT gateway 938.

The control plane VCN 916 can include a data plane mirror app tier 940 (e.g., the data plane mirror app tier 840 of FIG. 8) that can include app subnet(s) 926. The app subnet(s) 926 contained in the data plane mirror app tier 940 can include a virtual network interface controller (VNIC) 942 (e.g., the VNIC of 842) that can execute a compute instance 944 (e.g., similar to the compute instance 844 of FIG. 8). The compute instance 944 can facilitate communication between the app subnet(s) 926 of the data plane mirror app tier 940 and the app subnet(s) 926 that can be contained in a data plane app tier 946 (e.g., the data plane app tier 846 of FIG. 8) via the VNIC 942 contained in the data plane mirror app tier 940 and the VNIC 942 contained in the data plane app tier 946.

The Internet gateway 934 contained in the control plane VCN 916 can be communicatively coupled to a metadata management service 952 (e.g., the metadata management service 852 of FIG. 8) that can be communicatively coupled to public Internet 954 (e.g., public Internet 854 of FIG. 8). Public Internet 954 can be communicatively coupled to the NAT gateway 938 contained in the control plane VCN 916. The service gateway 936 contained in the control plane VCN 916 can be communicatively couple to cloud services 956 (e.g., cloud services 856 of FIG. 8).

In some examples, the data plane VCN 918 can be contained in the customer tenancy 921. In this case, the IaaS provider may provide the control plane VCN 916 for each customer, and the IaaS provider may, for each customer, set up a unique compute instance 944 that is contained in the service tenancy 919. Each compute instance 944 may allow communication between the control plane VCN 916, contained in the service tenancy 919, and the data plane VCN 918 that is contained in the customer tenancy 921. The compute instance 944 may allow resources, that are provisioned in the control plane VCN 916 that is contained in the service tenancy 919, to be deployed or otherwise used in the data plane VCN 918 that is contained in the customer tenancy 921.

In other examples, the customer of the IaaS provider may have databases that live in the customer tenancy 921. In this example, the control plane VCN 916 can include the data plane mirror app tier 940 that can include app subnet(s) 926. The data plane mirror app tier 940 can reside in the data plane VCN 918, but the data plane mirror app tier 940 may not live in the data plane VCN 918. That is, the data plane mirror app tier 940 may have access to the customer tenancy 921, but the data plane mirror app tier 940 may not exist in the data plane VCN 918 or be owned or operated by the customer of the IaaS provider. The data plane mirror app tier 940 may be configured to make calls to the data plane VCN 918 but may not be configured to make calls to any entity contained in the control plane VCN 916. The customer may desire to deploy or otherwise use resources in the data plane VCN 918 that are provisioned in the control plane VCN 916, and the data plane mirror app tier 940 can facilitate the desired deployment, or other usage of resources, of the customer.

In some embodiments, the customer of the IaaS provider can apply filters to the data plane VCN 918. In this embodiment, the customer can determine what the data plane VCN 918 can access, and the customer may restrict access to public Internet 954 from the data plane VCN 918. The IaaS provider may not be able to apply filters or otherwise control access of the data plane VCN 918 to any outside networks or databases. Applying filters and controls by the customer onto the data plane VCN 918, contained in the customer tenancy 921, can help isolate the data plane VCN 918 from other customers and from public Internet 954.

In some embodiments, cloud services 956 can be called by the service gateway 936 to access services that may not exist on public Internet 954, on the control plane VCN 916, or on the data plane VCN 918. The connection between cloud services 956 and the control plane VCN 916 or the data plane VCN 918 may not be live or continuous. Cloud services 956 may exist on a different network owned or operated by the IaaS provider. Cloud services 956 may be configured to receive calls from the service gateway 936 and may be configured to not receive calls from public Internet 954. Some cloud services 956 may be isolated from other cloud services 956, and the control plane VCN 916 may be isolated from cloud services 956 that may not be in the same region as the control plane VCN 916. For example, the control plane VCN 916 may be located in “Region 1,” and cloud service “Deployment 8,” may be located in Region 1 and in “Region 2.” If a call to Deployment 8 is made by the service gateway 936 contained in the control plane VCN 916 located in Region 1, the call may be transmitted to Deployment 8 in Region 1. In this example, the control plane VCN 916, or Deployment 8 in Region 1, may not be communicatively coupled to, or otherwise in communication with, Deployment 8 in Region 2.

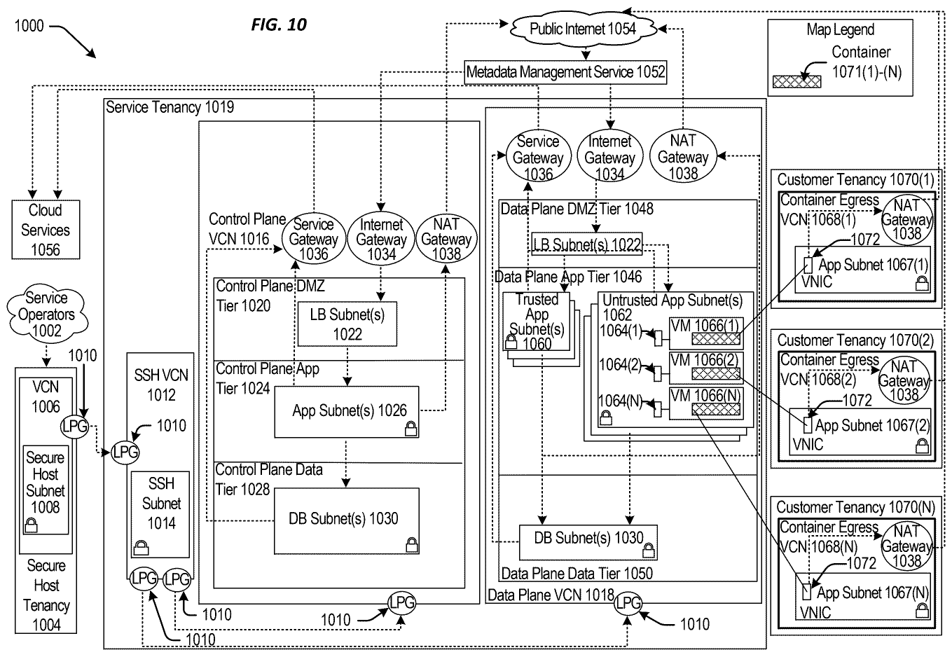

FIG. 10 is a block diagram 1000 illustrating another example pattern of an IaaS architecture, according to at least one embodiment. Service operators 1002 (e.g., service operators 802 of FIG. 8) can be communicatively coupled to a secure host tenancy 1004 (e.g., the secure host tenancy 804 of FIG. 8) that can include a virtual cloud network (VCN) 1006 (e.g., the VCN 806 of FIG. 8) and a secure host subnet 1008 (e.g., the secure host subnet 808 of FIG. 8). The VCN 1006 can include an LPG 1010 (e.g., the LPG 810 of FIG. 8) that can be communicatively coupled to an SSH VCN 1012 (e.g., the SSH VCN 812 of FIG. 8) via an LPG 1010 contained in the SSH VCN 1012. The SSH VCN 1012 can include an SSH subnet 1014 (e.g., the SSH subnet 814 of FIG. 8), and the SSH VCN 1012 can be communicatively coupled to a control plane VCN 1016 (e.g., the control plane VCN 816 of FIG. 8) via an LPG 1010 contained in the control plane VCN 1016 and to a data plane VCN 1018 (e.g., the data plane 818 of FIG. 8) via an LPG 1010 contained in the data plane VCN 1018. The control plane VCN 1016 and the data plane VCN 1018 can be contained in a service tenancy 1019 (e.g., the service tenancy 819 of FIG. 8).

The control plane VCN 1016 can include a control plane DMZ tier 1020 (e.g., the control plane DMZ tier 820 of FIG. 8) that can include load balancer (LB) subnet(s) 1022 (e.g., LB subnet(s) 822 of FIG. 8), a control plane app tier 1024 (e.g., the control plane app tier 824 of FIG. 8) that can include app subnet(s) 1026 (e.g., similar to app subnet(s) 826 of FIG. 8), a control plane data tier 1028 (e.g., the control plane data tier 828 of FIG. 8) that can include DB subnet(s) 1030. The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 834 of FIG. 8) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 8) and a network address translation (NAT) gateway 1038 (e.g., the NAT gateway 838 of FIG. 8). The control plane VCN 1016 can include the service gateway 1036 and the NAT gateway 1038.

The data plane VCN 1018 can include a data plane app tier 1046 (e.g., the data plane app tier 846 of FIG. 8), a data plane DMZ tier 1048 (e.g., the data plane DMZ tier 848 of FIG. 8), and a data plane data tier 1050 (e.g., the data plane data tier 850 of FIG. 8). The data plane DMZ tier 1048 can include LB subnet(s) 1022 that can be communicatively coupled to trusted app subnet(s) 1060 and untrusted app subnet(s) 1062 of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include one or more primary VNICs 1064(1)-(N) that can be communicatively coupled to tenant virtual machines (VMs) 1066(1)-(N). Each tenant VM 1066(1)-(N) can be communicatively coupled to a respective app subnet 1067(1)-(N) that can be contained in respective container egress VCNs 1068(1)-(N) that can be contained in respective customer tenancies 1070(1)-(N). Respective secondary VNICs 1072(1)-(N) can facilitate communication between the untrusted app subnet(s) 1062 contained in the data plane VCN 1018 and the app subnet contained in the container egress VCNs 1068(1)-(N). Each container egress VCNs 1068(1)-(N) can include a NAT gateway 1038 that can be communicatively coupled to public Internet 1054 (e.g., public Internet 854 of FIG. 8).

The Internet gateway 1034 contained in the control plane VCN 1016 and contained in the data plane VCN 1018 can be communicatively coupled to a metadata management service 1052 (e.g., the metadata management system 852 of FIG. 8) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some embodiments, the data plane VCN 1018 can be integrated with customer tenancies 1070. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1046. Code to run the function may be executed in the VMs 1066(1)-(N), and the code may not be configured to run anywhere else on the data plane VCN 1018. Each VM 1066(1)-(N) may be connected to one customer tenancy 1070. Respective containers 1071(1)-(N) contained in the VMs 1066(1)-(N) may be configured to run the code. In this case, there can be a dual isolation (e.g., the containers 1071(1)-(N) running code, where the containers 1071(1)-(N) may be contained in at least the VM 1066(1)-(N) that are contained in the untrusted app subnet(s) 1062), which may help prevent incorrect or otherwise undesirable code from damaging the network of the IaaS provider or from damaging a network of a different customer. The containers 1071(1)-(N) may be communicatively coupled to the customer tenancy 1070 and may be configured to transmit or receive data from the customer tenancy 1070. The containers 1071(1)-(N) may not be configured to transmit or receive data from any other entity in the data plane VCN 1018. Upon completion of running the code, the IaaS provider may kill or otherwise dispose of the containers 1071(1)-(N).

In some embodiments, the trusted app subnet(s) 1060 may run code that may be owned or operated by the IaaS provider. In this embodiment, the trusted app subnet(s) 1060 may be communicatively coupled to the DB subnet(s) 1030 and be configured to execute CRUD operations in the DB subnet(s) 1030. The untrusted app subnet(s) 1062 may be communicatively coupled to the DB subnet(s) 1030, but in this embodiment, the untrusted app subnet(s) may be configured to execute read operations in the DB subnet(s) 1030. The containers 1071(1)-(N) that can be contained in the VM 1066(1)-(N) of each customer and that may run code from the customer may not be communicatively coupled with the DB subnet(s) 1030.

In other embodiments, the control plane VCN 1016 and the data plane VCN 1018 may not be directly communicatively coupled. In this embodiment, there may be no direct communication between the control plane VCN 1016 and the data plane VCN 1018. However, communication can occur indirectly through at least one method. An LPG 1010 may be established by the IaaS provider that can facilitate communication between the control plane VCN 1016 and the data plane VCN 1018. In another example, the control plane VCN 1016 or the data plane VCN 1018 can make a call to cloud services 1056 via the service gateway 1036. For example, a call to cloud services 1056 from the control plane VCN 1016 can include a request for a service that can communicate with the data plane VCN 1018.

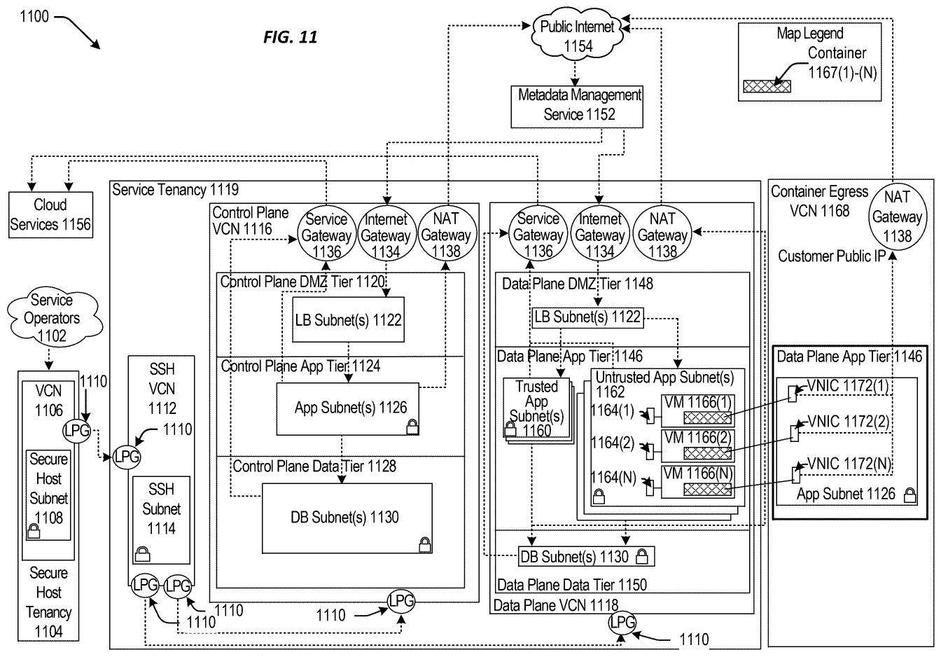

FIG. 11 is a block diagram 1100 illustrating another example pattern of an IaaS architecture, according to at least one embodiment. Service operators 1102 (e.g., service operators 802 of FIG. 8) can be communicatively coupled to a secure host tenancy 1104 (e.g., the secure host tenancy 804 of FIG. 8) that can include a virtual cloud network (VCN) 1106 (e.g., the VCN 806 of FIG. 8) and a secure host subnet 1108 (e.g., the secure host subnet 808 of FIG. 8). The VCN 1106 can include an LPG 1110 (e.g., the LPG 810 of FIG. 8) that can be communicatively coupled to an SSH VCN 1112 (e.g., the SSH VCN 812 of FIG. 8) via an LPG 1110 contained in the SSH VCN 1112. The SSH VCN 1112 can include an SSH subnet 1114 (e.g., the SSH subnet 814 of FIG. 8), and the SSH VCN 1112 can be communicatively coupled to a control plane VCN 1116 (e.g., the control plane VCN 816 of FIG. 8) via an LPG 1110 contained in the control plane VCN 1116 and to a data plane VCN 1118 (e.g., the data plane 818 of FIG. 8) via an LPG 1110 contained in the data plane VCN 1118. The control plane VCN 1116 and the data plane VCN 1118 can be contained in a service tenancy 1119 (e.g., the service tenancy 819 of FIG. 8).

The control plane VCN 1116 can include a control plane DMZ tier 1120 (e.g., the control plane DMZ tier 820 of FIG. 8) that can include LB subnet(s) 1122 (e.g., LB subnet(s) 822 of FIG. 8), a control plane app tier 1124 (e.g., the control plane app tier 824 of FIG. 8) that can include app subnet(s) 1126 (e.g., app subnet(s) 826 of FIG. 8), a control plane data tier 1128 (e.g., the control plane data tier 828 of FIG. 8) that can include DB subnet(s) 1130 (e.g., DB subnet(s) 1030 of FIG. 10). The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 834 of FIG. 8) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 8) and a network address translation (NAT) gateway 1138 (e.g., the NAT gateway 838 of FIG. 8). The control plane VCN 1116 can include the service gateway 1136 and the NAT gateway 1138.

The data plane VCN 1118 can include a data plane app tier 1146 (e.g., the data plane app tier 846 of FIG. 8), a data plane DMZ tier 1148 (e.g., the data plane DMZ tier 848 of FIG. 8), and a data plane data tier 1150 (e.g., the data plane data tier 850 of FIG. 8). The data plane DMZ tier 1148 can include LB subnet(s) 1122 that can be communicatively coupled to trusted app subnet(s) 1160 (e.g., trusted app subnet(s) 1060 of FIG. 10) and untrusted app subnet(s) 1162 (e.g., untrusted app subnet(s) 1062 of FIG. 10) of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include primary VNICs 1164(1)-(N) that can be communicatively coupled to tenant virtual machines (VMs) 1166(1)-(N) residing within the untrusted app subnet(s) 1162. Each tenant VM 1166(1)-(N) can run code in a respective container 1167(1)-(N), and be communicatively coupled to an app subnet 1126 that can be contained in a data plane app tier 1146 that can be contained in a container egress VCN 1168. Respective secondary VNICs 1172(1)-(N) can facilitate communication between the untrusted app subnet(s) 1162 contained in the data plane VCN 1118 and the app subnet contained in the container egress VCN 1168. The container egress VCN can include a NAT gateway 1138 that can be communicatively coupled to public Internet 1154 (e.g., public Internet 854 of FIG. 8).

The Internet gateway 1134 contained in the control plane VCN 1116 and contained in the data plane VCN 1118 can be communicatively coupled to a metadata management service 1152 (e.g., the metadata management system 852 of FIG. 8) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some examples, the pattern illustrated by the architecture of block diagram 1100 of FIG. 11 may be considered an exception to the pattern illustrated by the architecture of block diagram 1000 of FIG. 10 and may be desirable for a customer of the IaaS provider if the IaaS provider cannot directly communicate with the customer (e.g., a disconnected region). The respective containers 1167(1)-(N) that are contained in the VMs 1166(1)-(N) for each customer can be accessed in real-time by the customer. The containers 1167(1)-(N) may be configured to make calls to respective secondary VNICs 1172(1)-(N) contained in app subnet(s) 1126 of the data plane app tier 1146 that can be contained in the container egress VCN 1168. The secondary VNICs 1172(1)-(N) can transmit the calls to the NAT gateway 1138 that may transmit the calls to public Internet 1154. In this example, the containers 1167(1)-(N) that can be accessed in real-time by the customer can be isolated from the control plane VCN 1116 and can be isolated from other entities contained in the data plane VCN 1118. The containers 1167(1)-(N) may also be isolated from resources from other customers.

In other examples, the customer can use the containers 1167(1)-(N) to call cloud services 1156. In this example, the customer may run code in the containers 1167(1)-(N) that requests a service from cloud services 1156. The containers 1167(1)-(N) can transmit this request to the secondary VNICs 1172(1)-(N) that can transmit the request to the NAT gateway that can transmit the request to public Internet 1154. Public Internet 1154 can transmit the request to LB subnet(s) 1122 contained in the control plane VCN 1116 via the Internet gateway 1134. In response to determining the request is valid, the LB subnet(s) can transmit the request to app subnet(s) 1126 that can transmit the request to cloud services 1156 via the service gateway 1136.

It should be appreciated that IaaS architectures 800, 900, 1000, 1100 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

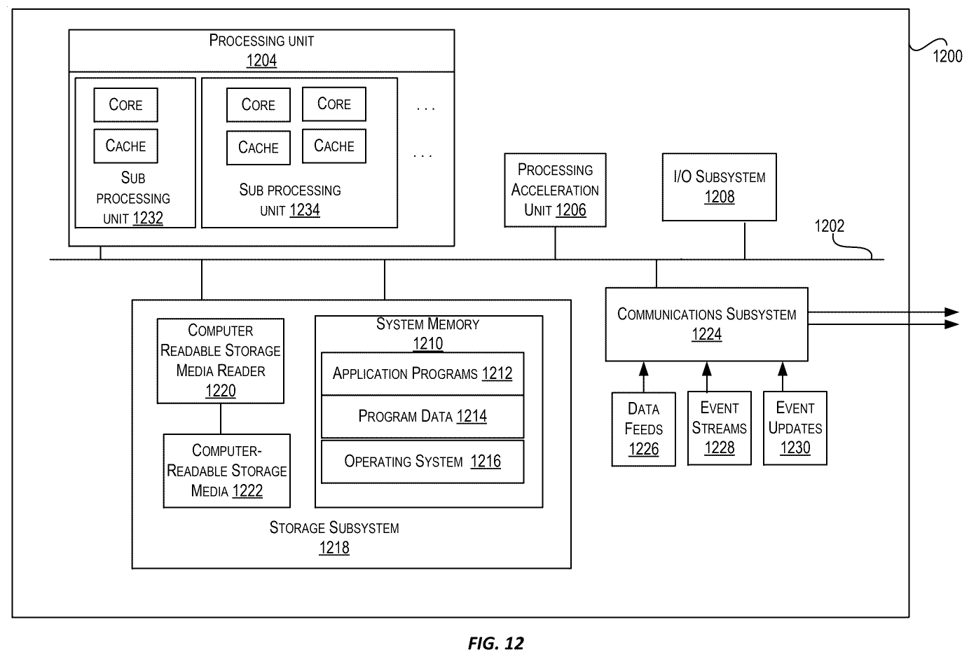

FIG. 12 illustrates an example computer system 1200, in which various embodiments may be implemented. The system 1200 may be used to implement any of the computer systems described above. As shown in the figure, computer system 1200 includes a processing unit 1204 that communicates with a number of peripheral subsystems via a bus subsystem 1202. These peripheral subsystems may include a processing acceleration unit 1206, an I/O subsystem 1208, a storage subsystem 1218 and a communications subsystem 1224. Storage subsystem 1218 includes tangible computer-readable storage media 1222 and a system memory 1210.

Bus subsystem 1202 provides a mechanism for letting the various components and subsystems of computer system 1200 communicate with each other as intended. Although bus subsystem 1202 is shown schematically as a single bus, alternative embodiments of the bus subsystem may utilize multiple buses. Bus subsystem 1202 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1204, which can be implemented as one or more integrated circuits (e.g., a conventional microprocessor or microcontroller), controls the operation of computer system 1200. One or more processors may be included in processing unit 1204. These processors may include single core or multicore processors. In certain embodiments, processing unit 1204 may be implemented as one or more independent processing units 1232 and/or 1234 with single or multicore processors included in each processing unit. In other embodiments, processing unit 1204 may also be implemented as a quad-core processing unit formed by integrating two dual-core processors into a single chip.

In various embodiments, processing unit 1204 can execute a variety of programs in response to program code and can maintain multiple concurrently executing programs or processes. At any given time, some or all of the program code to be executed can be resident in processor(s) 1204 and/or in storage subsystem 1218. Through suitable programming, processor(s) 1204 can provide various functionalities described above. Computer system 1200 may additionally include a processing acceleration unit 1206, which can include a digital signal processor (DSP), a special-purpose processor, and/or the like.

I/O subsystem 1208 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1200 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1200 may comprise a storage subsystem 1218 that comprises software elements, shown as being currently located within a system memory 1210. System memory 1210 may store program instructions that are loadable and executable on processing unit 1204, as well as data generated during the execution of these programs.

Depending on the configuration and type of computer system 1200, system memory 1210 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1204. In some implementations, system memory 1210 may include multiple different types of memory, such as static random access memory (SRAM) or dynamic random access memory (DRAM). In some implementations, a basic input/output system (BIOS), containing the basic routines that help to transfer information between elements within computer system 1200, such as during start-up, may typically be stored in the ROM. By way of example, and not limitation, system memory 1210 also illustrates application programs 1212, which may include client applications, Web browsers, mid-tier applications, relational database management systems (RDBMS), etc., program data 1214, and an operating system 1216. By way of example, operating system 1216 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1218 may also provide a tangible computer-readable storage medium for storing the basic programming and data constructs that provide the functionality of some embodiments. Software (programs, code modules, instructions) that when executed by a processor provide the functionality described above may be stored in storage subsystem 1218. These software modules or instructions may be executed by processing unit 1204. Storage subsystem 1218 may also provide a repository for storing data used in accordance with the present disclosure.

Storage subsystem 1200 may also include a computer-readable storage media reader 1220 that can further be connected to computer-readable storage media 1222. Together and, optionally, in combination with system memory 1210, computer-readable storage media 1222 may comprehensively represent remote, local, fixed, and/or removable storage devices plus storage media for temporarily and/or more permanently containing, storing, transmitting, and retrieving computer-readable information.

Computer-readable storage media 1222 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1200.

By way of example, computer-readable storage media 1222 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1222 may include, but is not limited to, Zip® drives, flash memory cards, universal serial bus (USB) flash drives, secure digital (SD) cards, DVD disks, digital video tape, and the like. Computer-readable storage media 1222 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1200.

Communications subsystem 1224 provides an interface to other computer systems and networks. Communications subsystem 1224 serves as an interface for receiving data from and transmitting data to other systems from computer system 1200. For example, communications subsystem 1224 may enable computer system 1200 to connect to one or more devices via the Internet. In some embodiments communications subsystem 1224 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1224 can provide wired network connectivity (e.g., Ethernet) in addition to or instead of a wireless interface.

In some embodiments, communications subsystem 1224 may also receive input communication in the form of structured and/or unstructured data feeds 1226, event streams 1228, event updates 1230, and the like on behalf of one or more users who may use computer system 1200.

By way of example, communications subsystem 1224 may be configured to receive data feeds 1226 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1224 may also be configured to receive data in the form of continuous data streams, which may include event streams 1228 of real-time events and/or event updates 1230, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1224 may also be configured to output the structured and/or unstructured data feeds 1226, event streams 1228, event updates 1230, and the like to one or more databases that may be in communication with one or more streaming data source computers coupled to computer system 1200.

Computer system 1200 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1200 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
executing, by a model deployment system, a model inference accelerator layer to perform a set of optimizations on a machine learning (ML) model provided as input to the model inference accelerator layer, wherein the machine learning (ML) model is associated with model metadata;
executing, by the model inference accelerator layer, and based on the model metadata, the set of optimizations on the machine learning (ML) model to generate an optimized ML model, the executing comprising:
determining, by the model inference accelerator layer, and based on the model metadata, one or more model-specific optimizations from the set of optimizations to be applied to the ML model;
determining, by the model inference accelerator layer, and based on the model metadata, one or more target hardware-specific optimizations from the set of optimizations to be applied to the machine learning (ML) model;
generating, by the model inference accelerator layer, an intermediate representation (IR) format for the machine learning (ML) model, the intermediate representation format identifying the one or more model-specific optimizations to be applied to the machine learning (ML) model and a target hardware for deploying the machine learning (ML) model in a target environment;
compiling, by the model inference accelerator layer, the intermediate representation format of the machine learning (ML) model based on the one or more model-specific optimizations and the one or more target hardware-specific model optimizations to generate an optimized machine learning (ML) model; and
deploying, by the model deployment system, the optimized machine learning (ML) model to the target hardware for deploying the machine learning (ML) model in the target environment.

2. The computer-implemented method of claim 1, wherein the target hardware for deploying the ML model in the target environment is identified based on the model metadata.

3. The computer-implemented method of claim 2, wherein the model metadata comprises a type of model compiler for compiling the ML model, a target hardware for deploying the ML model in the target environment, a type of the ML model and a type of the ML model framework used to build the ML model.

4. The computer-implemented method of claim 1, wherein the target hardware identifies at least one of a Central Processing Unit (CPU) specification for deploying the ML model in the target environment, a Graphical Processing Unit (GPU) specification for deploying the ML model in the target environment or deployment accelerators for deploying the ML model in the target environment.

5. The computer-implemented method of claim 1, wherein the intermediate representation (IR) format for the IR model identifies a set of model components of the ML model to be deployed in the target environment.

6. The computer-implemented method of claim 1, wherein executing, by the model inference accelerator (MIA) layer, the set of model optimizations on the ML model to generate an optimized ML model further comprises:
generating, by the model inference accelerator (MIA) layer, a model inference script for executing the ML model in the target environment; and
transmitting, by the model inference accelerator (MIA) layer, the optimized ML model and the model inference script to a containerized environment in the MDS.

7. The computer-implemented method of claim 6, wherein the model inference script comprises a loading function to load the optimized ML model onto the target hardware in the target environment.

8. The computer-implemented method of claim 6, wherein the model inference script comprises a prediction function to return a predicted output from the ML model based on input data provided to the ML model.

9. The computer-implemented method of claim 1, wherein deploying, by the model deployment system (MDS), the ML model in the target environment further comprises:
mounting, by the model deployment system (MDS), a compilation environment comprising the optimized ML model and the model inference script to an inference container in the model deployment system (MDS); and
packaging, by the model deployment system (MDS), the compilation environment in an inference container image; and
deploying, by the model deployment system (MDS), the inference container image to the target device in the target environment.

10. The computer-implemented method of claim 9, further comprising:
receiving, by inference container image, a request to an inference endpoint to perform a prediction;
executing, by the inference container image, the optimized ML model to generate an inference result responsive to the request; and
transmitting, by the inference container image, the inference result to a source of the request.

11. A model deployment system comprising:
a memory; and
one or more processors configured to perform processing, the processing comprising:
executing, by the model deployment system, a model inference accelerator layer to perform a set of optimizations on a machine learning (ML) model provided as input to the model inference accelerator layer, wherein the ML model is associated with model metadata;
executing, by the model inference accelerator layer, and based on the model metadata, the set of optimizations on the ML model to generate an optimized ML model, the executing comprising:
determining, by the model inference accelerator layer, and based on the model metadata, one or more model-specific optimizations from the set of optimizations to be applied to the ML model;
determining, by the model inference accelerator layer, and based on the model metadata, one or more target hardware-specific optimizations from the set of optimizations to be applied to the ML model;
generating, by the model inference accelerator layer, an intermediate representation format for the machine learning (ML) model, the IR format identifying the one or more model-specific optimizations to be applied to the machine learning (ML) model and a target hardware for deploying the machine learning (ML) model in a target environment;
compiling, by the model inference accelerator layer, the IR format of the machine learning (ML) model based on the one or more model-specific optimizations and the one or more target hardware-specific model optimizations to generate an optimized machine learning (ML) model; and
deploying, by the model deployment system, the optimized ML model to the target hardware for deploying the machine learning (ML) model in the target environment.

12. The model deployment system of claim 11, wherein the target hardware for deploying the ML model in the target environment is identified based on the model metadata.

13. The model deployment system of claim 11, wherein the model metadata comprises a type of model compiler for compiling the ML model, a target hardware for deploying the ML model in the target environment, a type of the ML model and a type of the ML model framework used to build the ML model.

14. The model deployment system of claim 11, wherein the intermediate representation (IR) format for the IR model identifies a set of model components of the ML model to be deployed in the target environment.

15. The model deployment system of claim 11, wherein executing, by the model inference accelerator (MIA) layer, the set of model optimizations on the ML model to generate an optimized ML model further comprises:
generating, by the model inference accelerator (MIA) layer, a model inference script for executing the ML model in the target environment; and
transmitting, by the model inference accelerator (MIA) layer, the optimized ML model and the model inference script to a containerized environment in the MDS.

16. The model deployment system of claim 11, wherein the model inference script comprises a loading function to load the optimized ML model onto the target hardware in the target environment.

17. The model deployment system of claim 11,, wherein the model inference script comprises a prediction function to return a predicted output from the ML model based on input data provided to the ML model.

18. A non-transitory computer-readable medium storing instructions executable by a computer system that, when executed by one or more processors of the computer system, cause the one or more processors to perform operations comprising:
executing a model inference accelerator layer to perform a set of optimizations on a machine learning (ML) model provided as input to the model inference accelerator layer, wherein the machine learning (ML) model is associated with model metadata;
executing, by the model inference accelerator layer, and based on the model metadata, the set of optimizations on the machine learning (ML) model to generate an optimized ML model, the executing comprising:
determining, by the model inference accelerator layer, and based on the model metadata, one or more model-specific optimizations from the set of optimizations to be applied to the machine learning (ML) model;
determining, by the model inference accelerator layer, and based on the model metadata, one or more target hardware-specific optimizations from the set of optimizations to be applied to the ML model;
generating, by the model inference accelerator layer, an intermediate representation format for the IR model, the intermediate representation format identifying the one or more model-specific optimizations to be applied to the ML model and a target hardware for deploying the machine learning (ML) model in a target environment;
compiling, by the model inference accelerator layer, the intermediate representation format of the machine learning (ML) model based on the one or more model-specific optimizations and the one or more target hardware-specific model optimizations to generate an optimized machine learning (ML) model; and
deploying the optimized machine learning (ML) model to the target hardware for deploying the ML model in the target environment.

19. The non-transitory computer-readable medium of claim 18, wherein the target hardware for deploying the ML model in the target environment is identified based on the model metadata.

20. The non-transitory computer-readable medium of claim 18, wherein the model metadata comprises a type of model compiler for compiling the ML model, a target hardware for deploying the ML model in the target environment, a type of the ML model and a type of the ML model framework used to build the ML model.
